(19) United States
(12) Patent Application Publication
(10) Pub. No.: US 2018/0067970 A1
(43) Pub. Date: Mar. 8, 2018

(54) INTELLIGENT IMAGE SEARCH WITH PROXY LOCATION FILTER

(71) Applicant: Jari Kristensen, Kirkland, WA (US)

(72) Inventor: Jari Kristensen, Kirkland, WA (US)

(21) Appl. No.: 15/698,485

(22) Filed: Sep. 7, 2017

Related U.S. Application Data
(60) Provisional application No. 62/384,529, filed on Sep. 7, 2016.

(51) Int. Cl. G06F 17/30

(52) U.S. Cl. CPC G06F 17/30268; G06F 17/3087; G06F 17/30274; G06F 17/3028; G06F 17/30867

(57) ABSTRACT

An image search system is described herein that allows a user to be approximate about the location where an image was taken. Often a user has some idea where an image was taken (e.g., while we were on vacation in Europe, at the local mall, and so forth), and this can be a helpful criterion for identifying images. However, today's location based search often requires that the user be exact about the location where the photo was taken, which the user may be unable to do. With the image search system, the days of scrolling through your personal content to find what you are looking for are finally over. These “scrolling safaris” are particularly daunting because you are not quite sure that you will end up finding what you seek.

### BACKGROUND

Mobile search is distinct from desktop search because of screen size, input method, and the widespread prevalence of additional sensors, such as global positioning system (GPS) sensors, image capture (e.g., camera) sensors, and so forth. As a result, mobile search has the potential to be far more dynamic than a desktop search, in part by making use of additional available sensors.

One example of an area where users have particular difficulty searching is finding images (e.g., digital photos) in a large collection of images. Now that mobile devices are ubiquitous and commonly have image capture hardware, users are creating more images than ever before. Even a casual user may capture hundreds of images per day. As time passes, a user quickly has a large collection of images. In addition, users may share images, with each user creating a substantial number of images, which just adds to the problem.

Often the best a user can do today is to scroll through large lists (potentially hundreds of thousands or more) of images and hope to see the one the user is looking for. Some software solutions to this problem have been attempted, such as allowing a user to search by date a photo was taken. Advanced software attempts to recognize faces in the images and may allow a user to search for particular faces. However, for a typical family with a couple of kids, the same four people might be in each image over the course of decades of vacations, birthday parties, and other events. Finding the image a person is looking for is still very difficult.

### BRIEF DESCRIPTION OF THE DRAWINGS

FIG. 1 illustrates components of the image search system, in one embodiment.

FIG. 2 is a table that illustrates image search criteria, in one embodiment.

FIG. 3 shows a user's location over a period of time and the set of photos in the user's photo gallery that pertain to that location.

FIG. 4 illustrates the user slicing data by defining a first column that limits the search to a location search region, in one embodiment.

FIG. 5 illustrates the user slicing data by defining a second column that limits the search to a center location search, in one embodiment.

FIG. 6 illustrates the user slicing data by defining a third column that limits the search based on hashtags, in one embodiment.

FIG. 7 illustrates the effect of a user long pressing on an image to define a new search area, in one embodiment.

FIG. 8 illustrates a timeline search first column definition, in one embodiment.

FIG. 9 illustrates a timeline search second column definition, in one embodiment.

FIG. 10 illustrates a timeline search third column definition, in one embodiment.

FIG. 11 illustrates another example search first, second, and third column definition, in one embodiment.

FIG. 12 illustrates another example search first, second, and third column definition, in one embodiment.

FIG. 13 illustrates language definitions for data views, in one embodiment.

FIG. 14 illustrates possible combinations, in one embodiment.

FIG. 15 illustrates collection view portrait to collection view landscape, collection view portrait to item view portrait, and item view portrait to collection view landscape, in one embodiment.

FIG. 16 illustrates item view portrait to zoom view portrait, zoom view portrait to item view portrait, and zoom view portrait to zoom view landscape, in one embodiment.

FIG. 17 illustrates collection view landscape to collection view portrait, collection view landscape to collection view landscape, and collection view landscape to item view landscape, in one embodiment.

FIG. 18 illustrates item view landscape to collection view landscape, item view landscape to item view portrait, and item view landscape to zoom view landscape, in one embodiment.

FIG. 19 illustrates zoom view landscape to item view landscape and zoom view landscape to zoom view portrait, in one embodiment.

FIG. 20 is a screenshot that illustrates density of results, in one embodiment.

FIG. 21 illustrates a new interface to augment menu systems, in one embodiment.

FIG. 22 illustrates a user interface control that appears when there are two options facing each other, in one embodiment.

### DETAILED DESCRIPTION

An image search system is described herein that allows a user to be approximate about the location where an image was taken. Often a user has some idea where an image was taken (e.g., while we were on vacation in Europe, at the local mall, and so forth), and this can be a helpful criterion for identifying images. However, today's location based search often requires that the user be exact about the location where the photo was taken, which the user may be unable to do. With the image search system, the days of scrolling through your personal content to find what you are looking for are finally over. These “scrolling safaris” are particularly daunting because you are not quite sure that you will end up finding what you seek.

The image search system applies several techniques in combination to improve the nature of searching for content such as images. The first technique is referred to as time-date stamp intermediation. This technique uses time-date stamps, which most digital image capture devices associate with images automatically, as a connecting variable between two disparate databases to link them into one meta-database. The second technique is a location-relevancy algorithm. The location relevancy algorithm operates as a proximity-based, metasearch engine that does not require any indexing. The scope of the final result is determined by the spatial distribution of the initial results. The third technique is proxy location search input. When a user enters a mental map of the user's location history, the user cannot always remember the exact name of where an image was taken. More often than not, the user remembers something that caught the user's eye either before or after. The image search system can use the location that stood out to the user as a proxy for the actual location the user is looking for. Thus, the image search system provides an improved search experience that is more likely to lead the user to the intended result set.

### Components

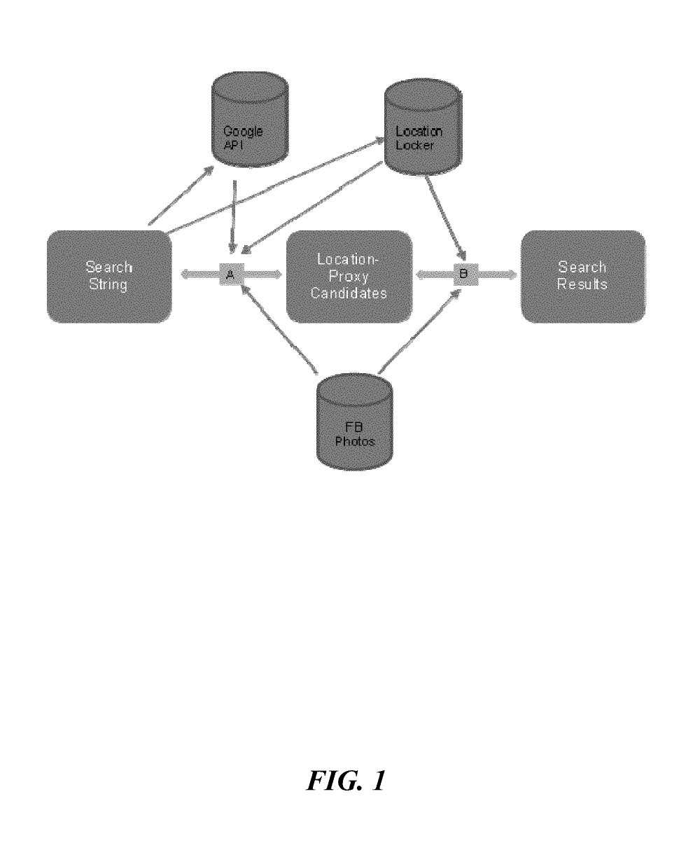

FIG. 1 illustrates components of the image search system, in one embodiment. The image search system contains multiple software components that work together to implement the system. Each of these components is described in further detail below.

The system includes a concept of a meta-search engine. The image search system is a meta-search engine for mobile. In every search, there are really two searches. The first search is to find the best location proxy for the actual action's location (and have some indication of the proxy's predictive value). The second search takes that location proxy and tries to find the desired image result set. In some embodiments, the image search system applies one formula to determine which image the user is looking for and another formula to find the image the user is looking for. These two may be different.

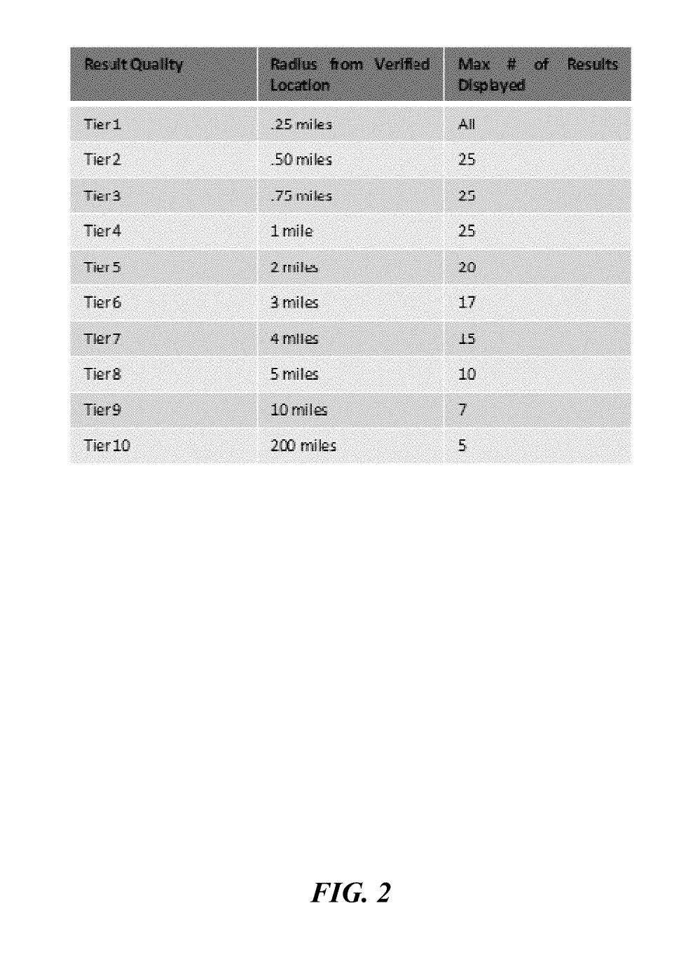

FIG. 2 is a table that illustrates image search criteria, in one embodiment. In some embodiments, the system applies the values in the table to determine which image the user is looking for. As shown in the table, some types of searches lend themselves to a smaller search radius, and smaller search radii allow more results to be displayed due to the higher level of precision. This makes sense as a user would not generally intend to see every image taken in the user's hometown if the search radius included the whole city, but would more likely want to see every image taken in the user's backyard, for a particular search.

The system includes a concept of a location locker. The location locker is a user's personal location history database. This tool enables our customers to unlock the insights of their location-history to everyday life. We can, finally, give location context to any piece of content—even if it does not have native geolocation metadata.

The system includes a concept of a location relevancy algorithm. The mission of this algorithm is to be the most productive search algorithm on mobile. Productive means the optimal mix of ease of use and accuracy of outcome. That balance can be different for mobile vs. desktop (as outlined above). In some embodiments, returning fewer results (in the best case, one) where each result is of a high quality is a greater indicator of success than returning a high number of results. From a functional perspective, the search algorithm more closely resembles a filter than a ranking engine.

The system includes a concept of a location proxy. If a user is searching for pictures at some restaurant in Bellevue, Wash. but only recalls that the restaurant was near Barrier Motors, then Barrier Motors is the location proxy. In our current documentation, this is the “Verified Location.”

One component of this product is the importance of privacy. We believe that users are going to place increasing importance on their privacy. This puts larger internet firms like Google and Apple at a competitive disadvantage in terms of being a credible place where consumers will store all of their location history data. In many ways, consumers are more likely to trust small firms than large ones to handle their data without ulterior motives.

The image search system stores an encrypted database of a user's location history on the user's mobile device and this can be backed-up to a cloud service of their choosing or the system's own services. If backed up to the cloud, the benefits of that location history database can be accessed from any Internet-connected device (e.g., computer, desktop, laptop, and so on) and leveraged through a variety of third party software and other applications. The location history database will be called by individual applications with discrete requests; to which temporary data will be provided. In some embodiments, at no time is the location history database shared in its entirety.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### How the Three Columns Work

In some embodiments, the image search system uses a three-column user interface paradigm in which each column may represent a dimension along which the user wants to filter the result set. For example, one column might pertain to location, another to date-time, and another to friends that were present. The three columns work together to form overlapping slices of data that refine the result set.

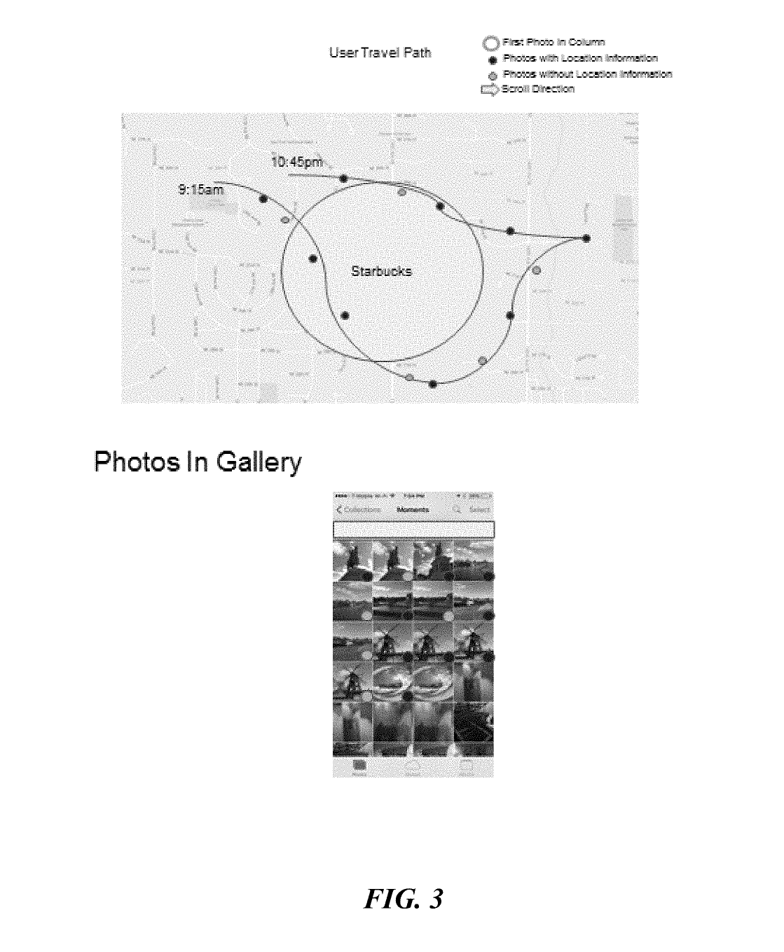

FIG. 3 shows a user's location over a period of time and the set of photos in the user's photo gallery that pertain to that location.

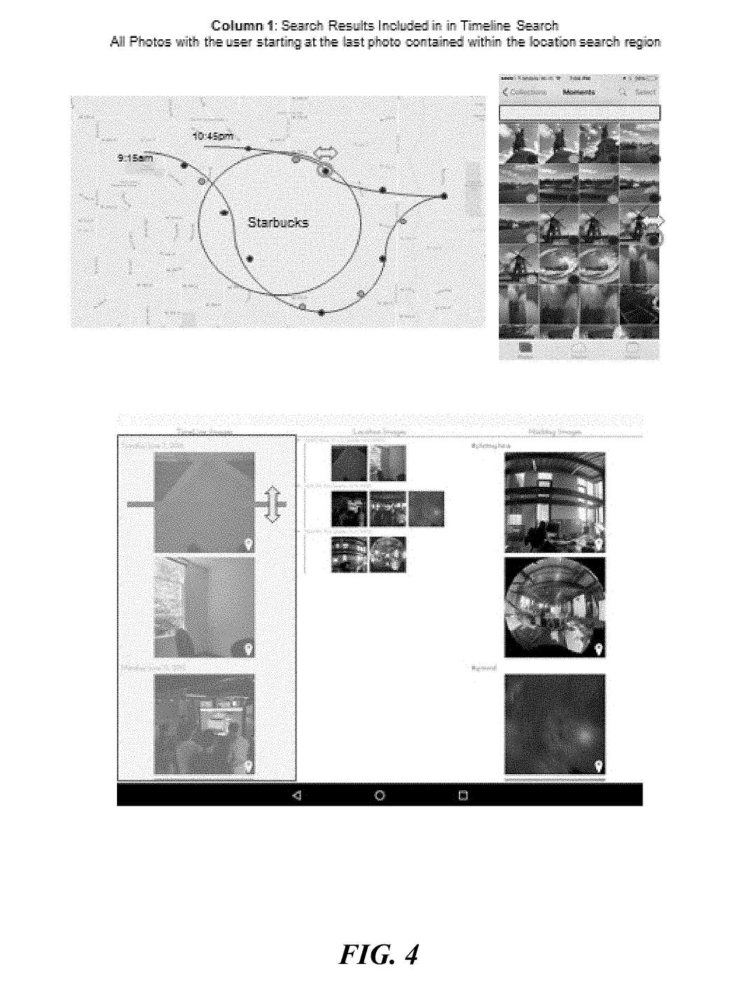

FIG. 4 illustrates the user slicing data by defining a first column that limits the search to a location search region, in one embodiment.

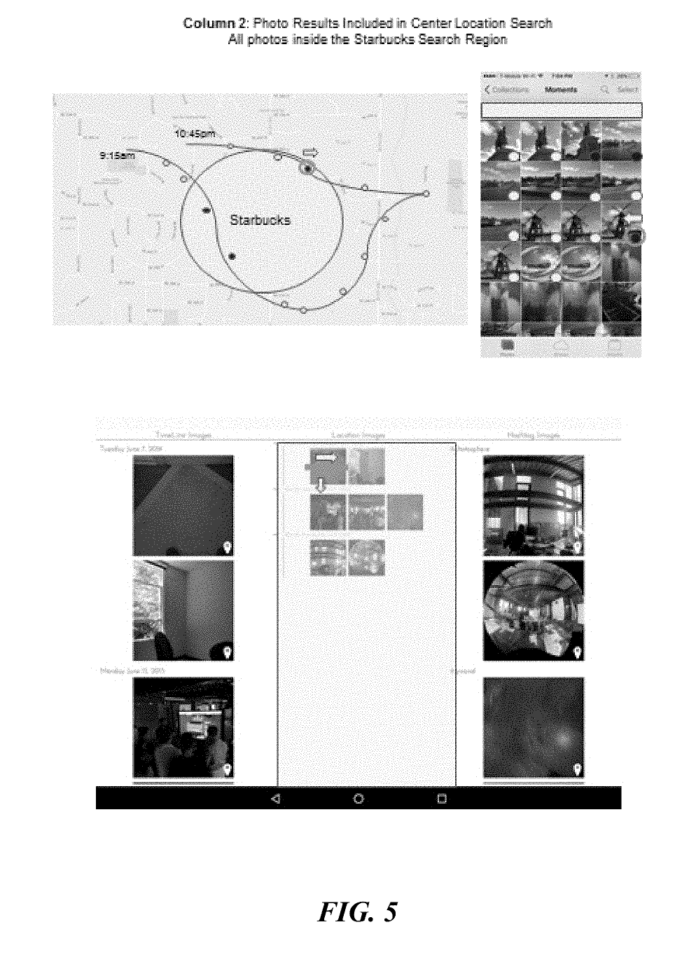

FIG. 5 illustrates the user slicing data by defining a second column that limits the search to a center location search, in one embodiment.

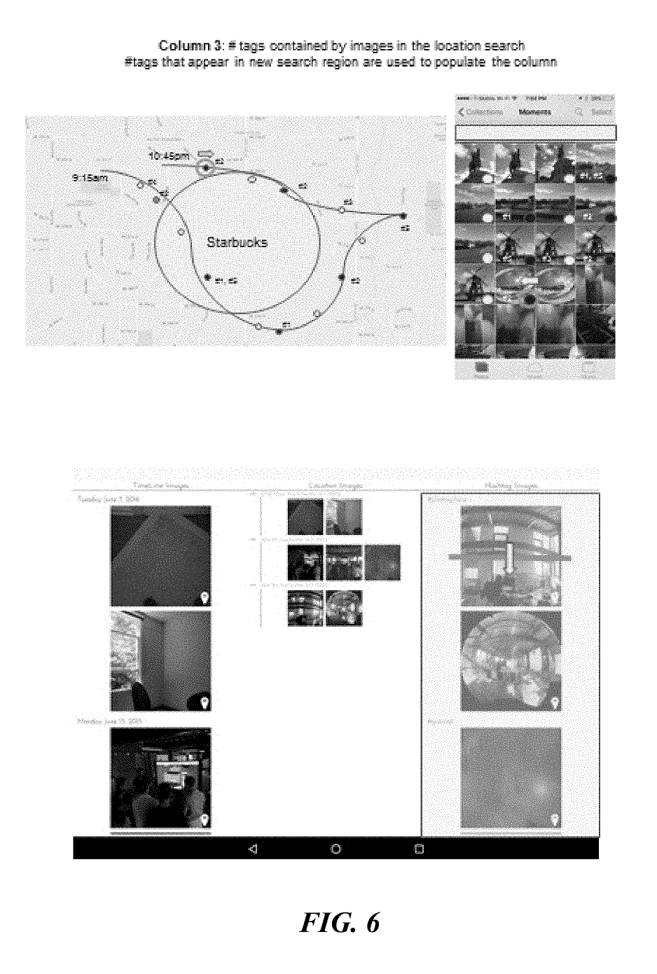

FIG. 6 illustrates the user slicing data by defining a third column that limits the search based on hashtags, in one embodiment.

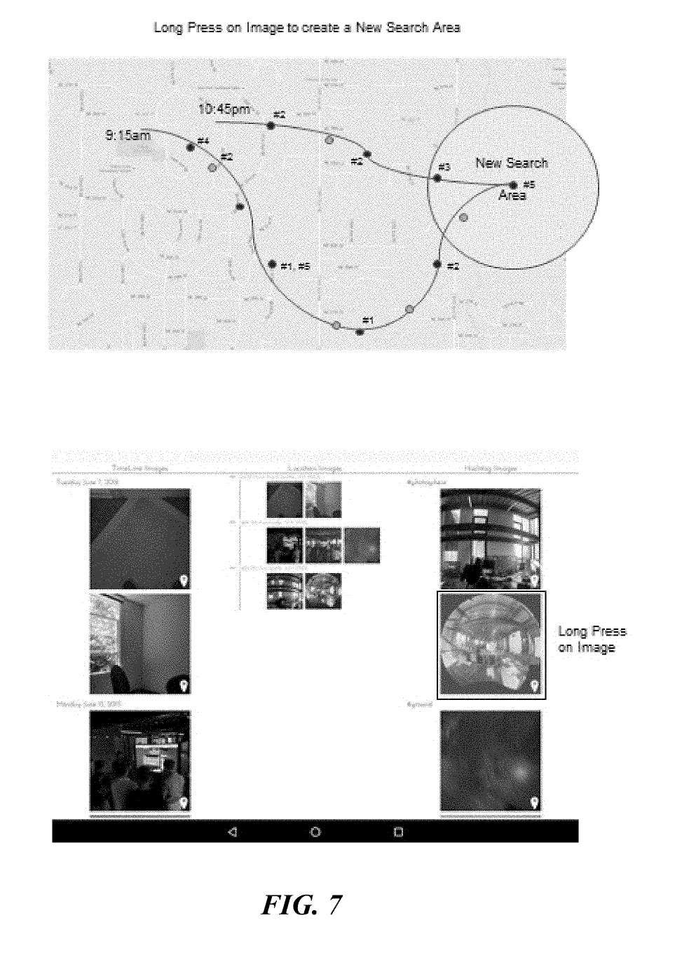

FIG. 7 illustrates the effect of a user long pressing on an image to define a new search area, in one embodiment.

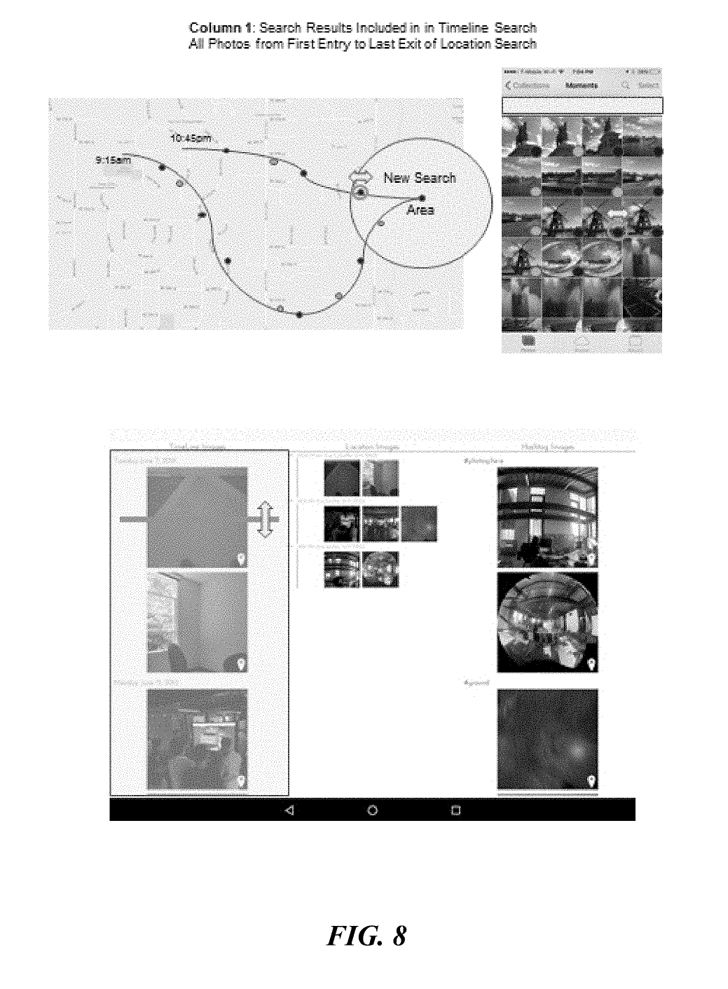

FIG. 8 illustrates a timeline search first column definition, in one embodiment.

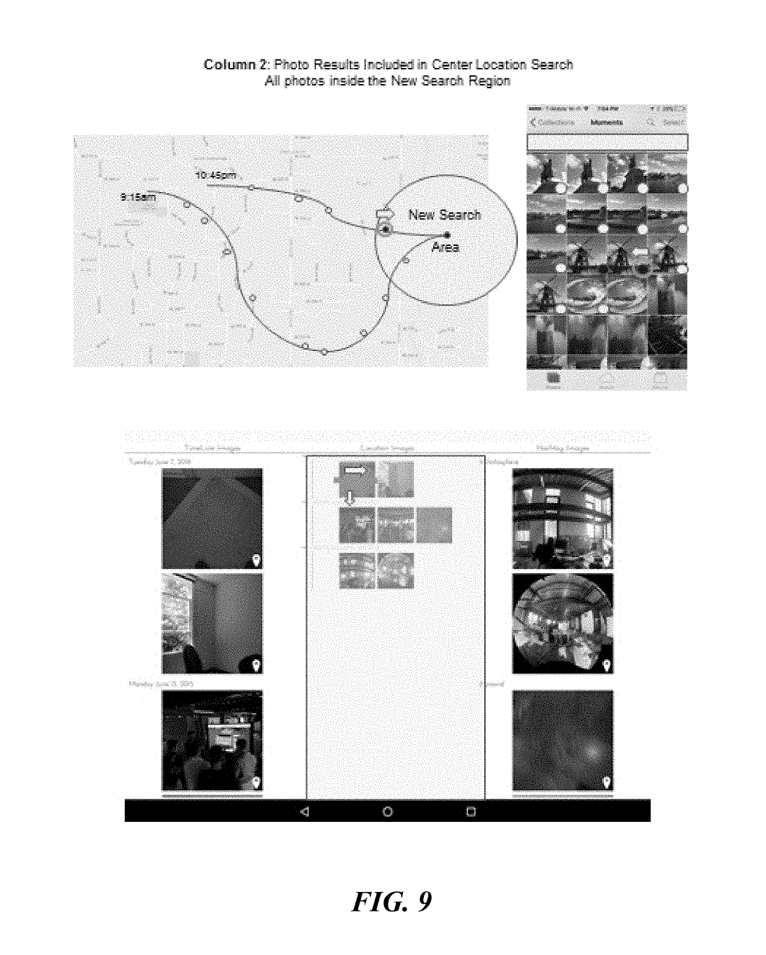

FIG. 9 illustrates a timeline search second column definition, in one embodiment.

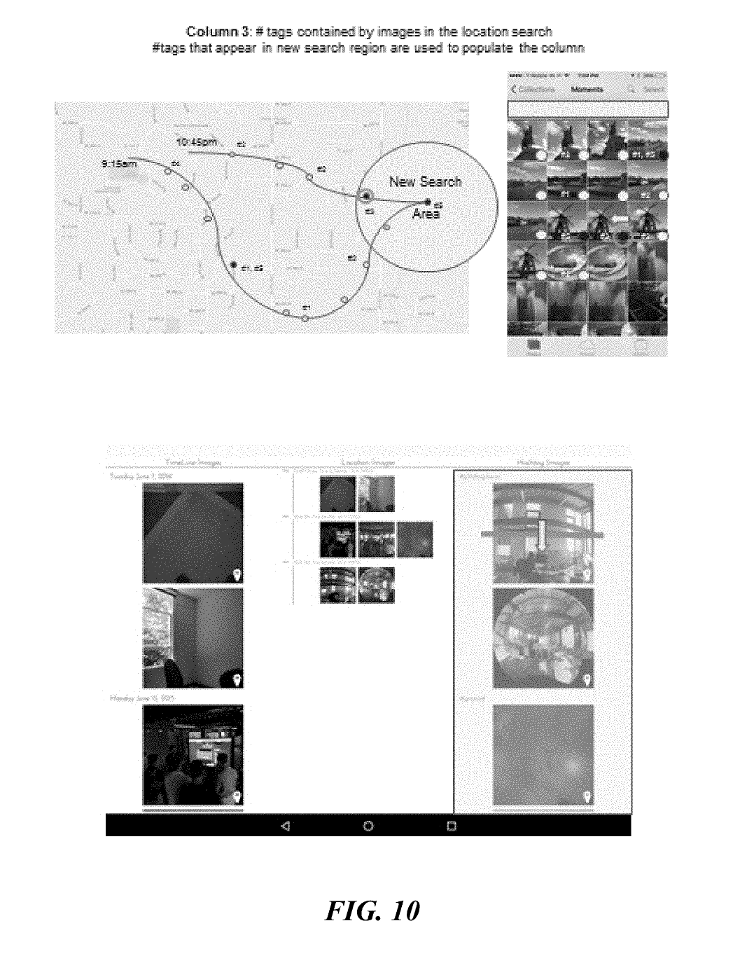

FIG. 10 illustrates a timeline search third column definition, in one embodiment.

### Another Example

The following images provide another example of using the three-column interface to identify images.

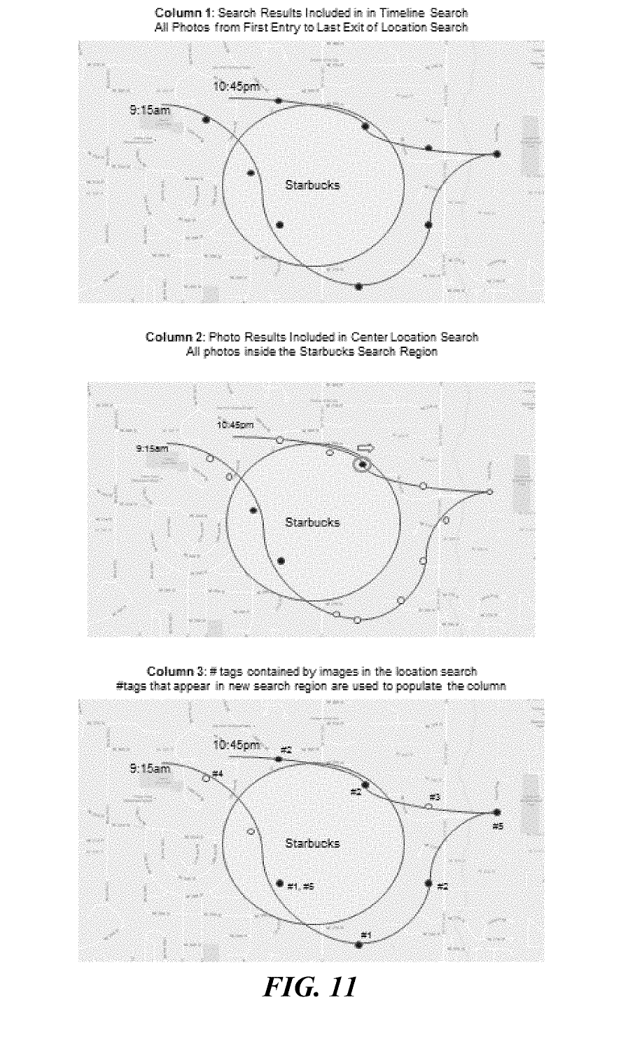

FIG. 11 illustrates another example search first, second, and third column definition, in one embodiment.

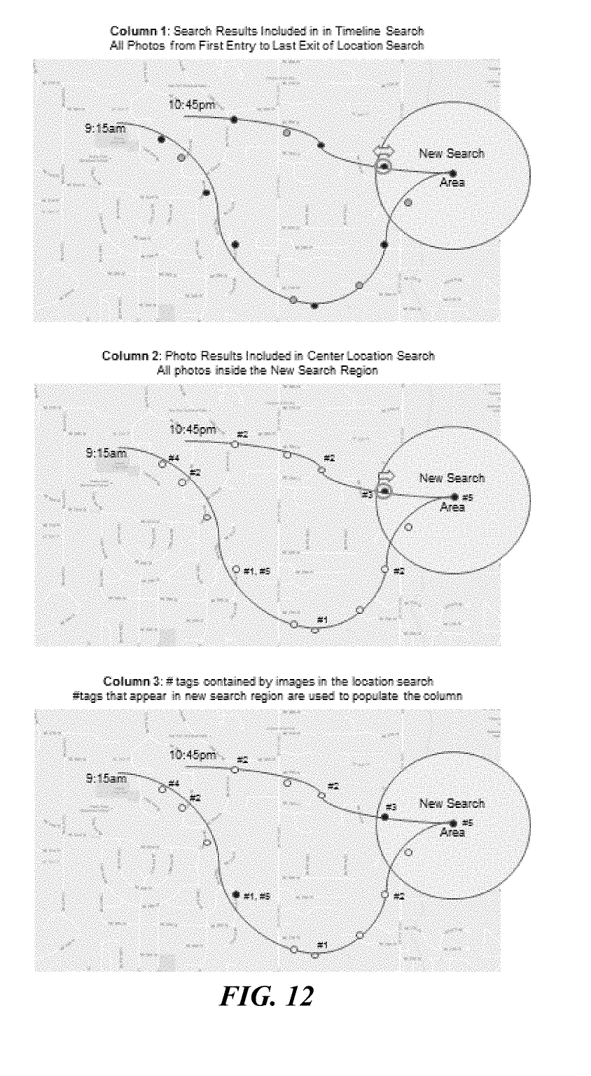

FIG. 12 illustrates another example search first, second, and third column definition, in one embodiment.

### Interface Navigation

The following images illustrate navigation through the user interface of the image search system, in some embodiments.

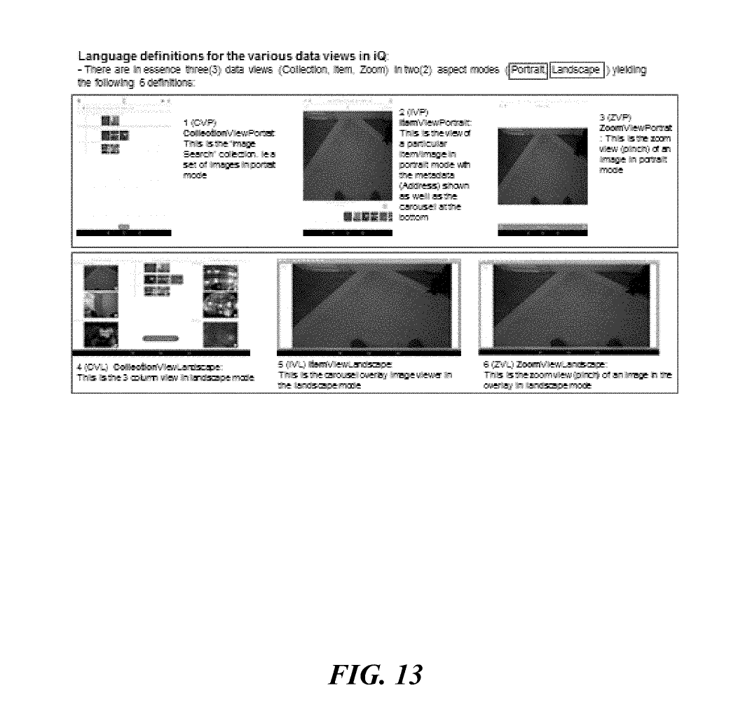

FIG. 13 illustrates language definitions for data views, in one embodiment.

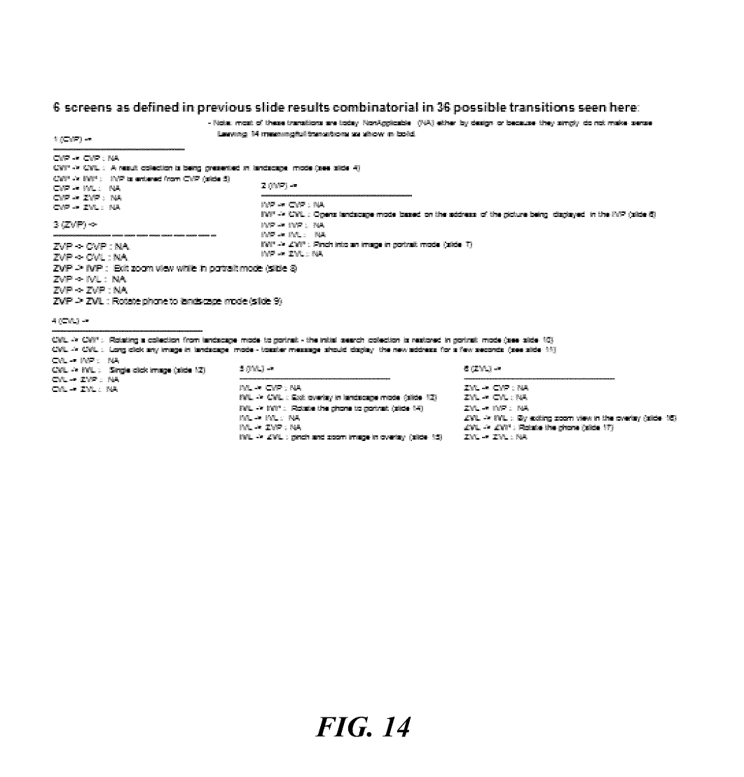

FIG. 14 illustrates possible combinations, in one embodiment.

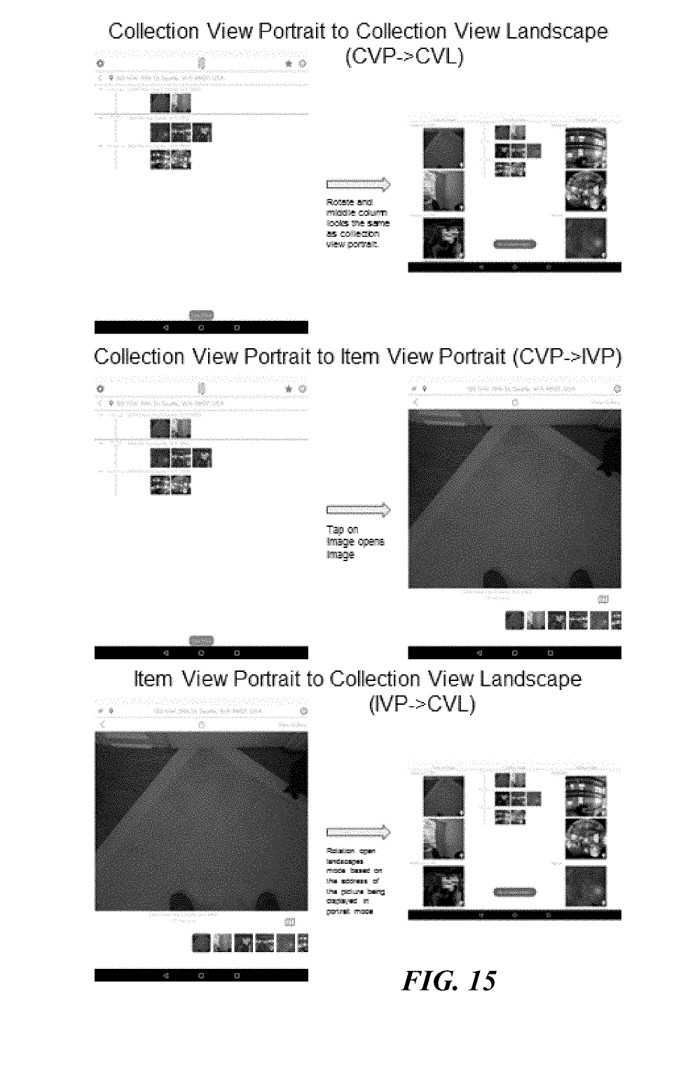

FIG. 15 illustrates collection view portrait to collection view landscape, collection view portrait to item view portrait, and item view portrait to collection view landscape, in one embodiment.

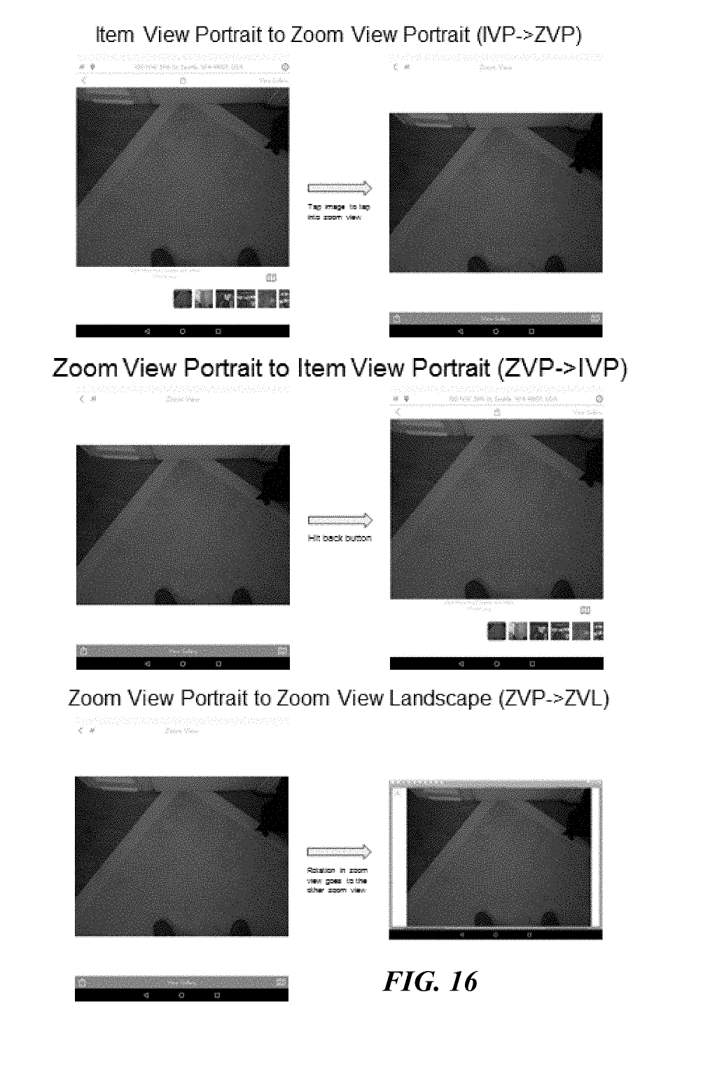

FIG. 16 illustrates item view portrait to zoom view portrait, zoom view portrait to item view portrait, and zoom view portrait to zoom view landscape, in one embodiment.

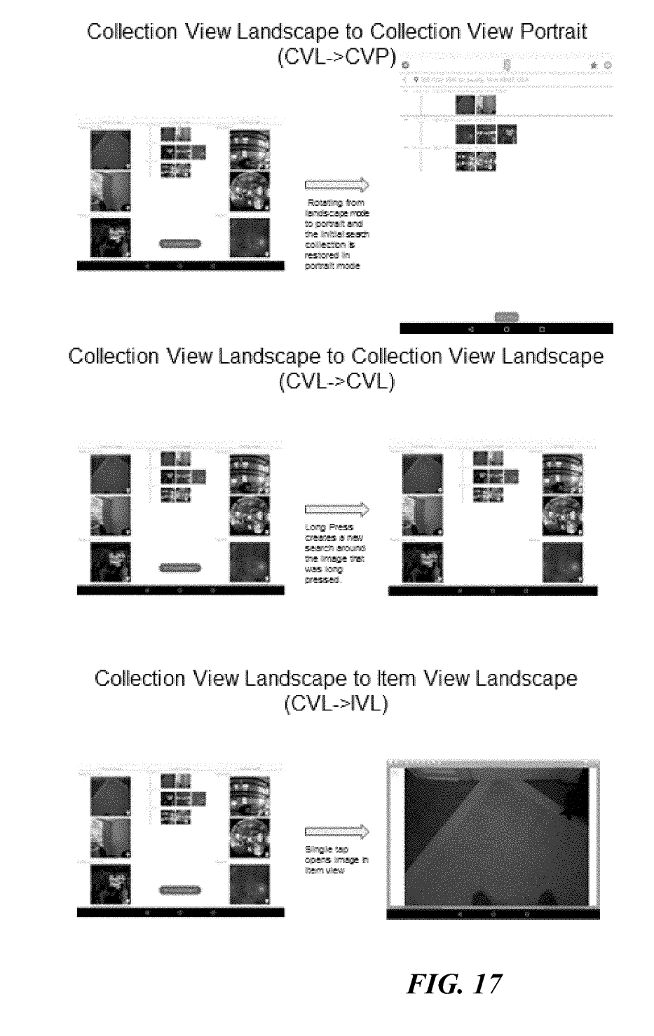

FIG. 17 illustrates collection view landscape to collection view portrait, collection view landscape to collection view landscape, and collection view landscape to item view landscape, in one embodiment.

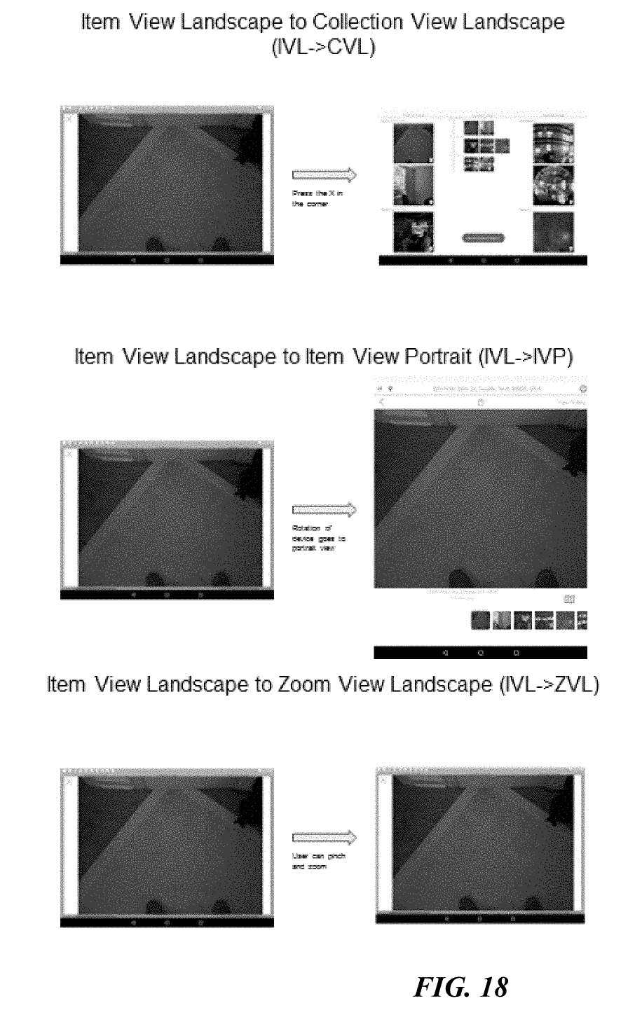

FIG. 18 illustrates item view landscape to collection view landscape, item view landscape to item view portrait, and item view landscape to zoom view landscape, in one embodiment.

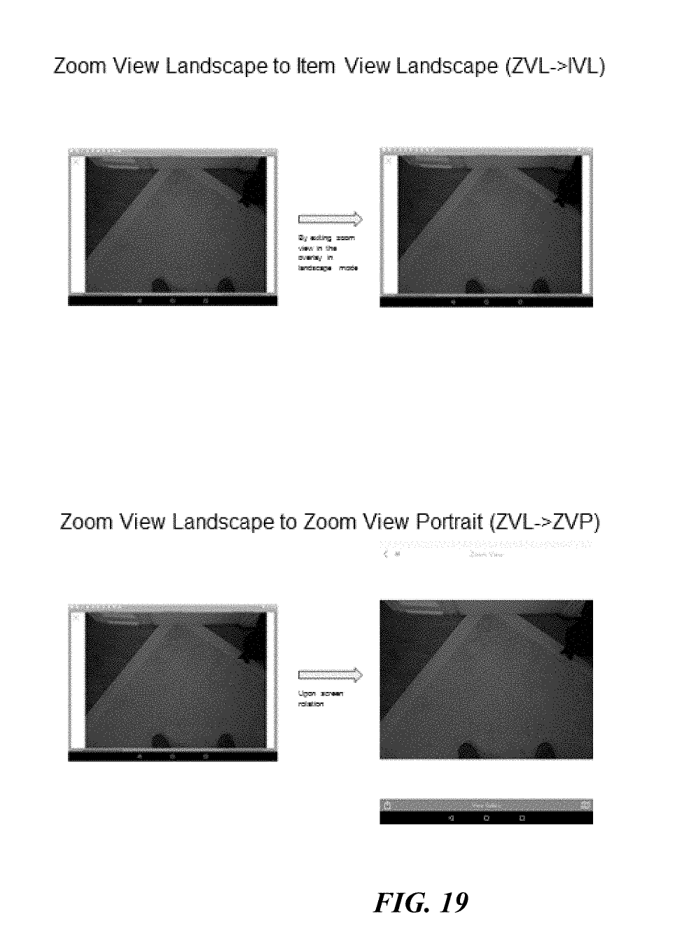

FIG. 19 illustrates zoom view landscape to item view landscape and zoom view landscape to zoom view portrait, in one embodiment.

In some embodiments, the image search system's mission is to become a user's location-context hub for everything. The Location Locker is at the center of this strategy. Results density is also an important differentiator of the system. The greater the density of results around proxy candidates the higher their score. Spatial distance score of the location proxy is another potential future input.

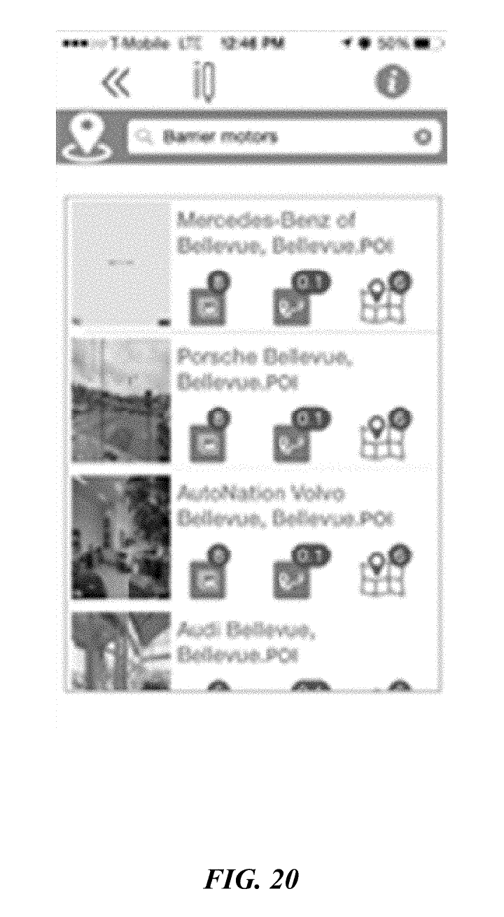

FIG. 20 is a screenshot that illustrates density of results, in one embodiment. In this screen shot, the location proxy is the red 0.1 icon. The icon with an eight next to that icon displays the number of photos within a 0.1-mile radius from the location proxy. How many results the location proxy has within a 0.1-mile radius from it is one of the scoping variables in the algorithm above. Proxies with fewer nearby results are scored lower than proxies with greater numbers of results.

Another potential future input to the image search system is a temporal distance score. The image search system, when evaluating the scope of results to display, will take into consideration the amount of time between presence at the proxy and time-date stamp in rankings.

In some embodiments, there can be many types of context on which a search can be based, depending on the particular domain of content. This allows the user to conduct searches based on the types of things the user remembers. For example, in the domain of phone calls, types of context might be location, call duration, weather that day, and so forth. A user might then input information indicating that the user remembers that the call the user is searching for was a longer call on a rainy day after the user ate at McDonald's. This is enough information for the system to rank the available phone call results by these types of context. For example, the system can use the call duration stored for the call to rank results to find longer calls, can use location information to determine when the user was at McDonald's, and so forth.

In some embodiments, a secure connection can be established between a user and a service or a user and another user, just by scanning a QR code with the user's phone, without any other account or password being needed. By scanning a particular session code on a particular screen, a secure pipeline can be established. The user's smart device (e.g., smartphone) is essentially the password for the user. This provides a trusted relationship with any browser using just a user's smart device, with nothing else to remember. Rather than going to a portal and storing a user's secret on some cloud based server, the user's phone is the user's secure agent and stores the user's credential information locally to the user.

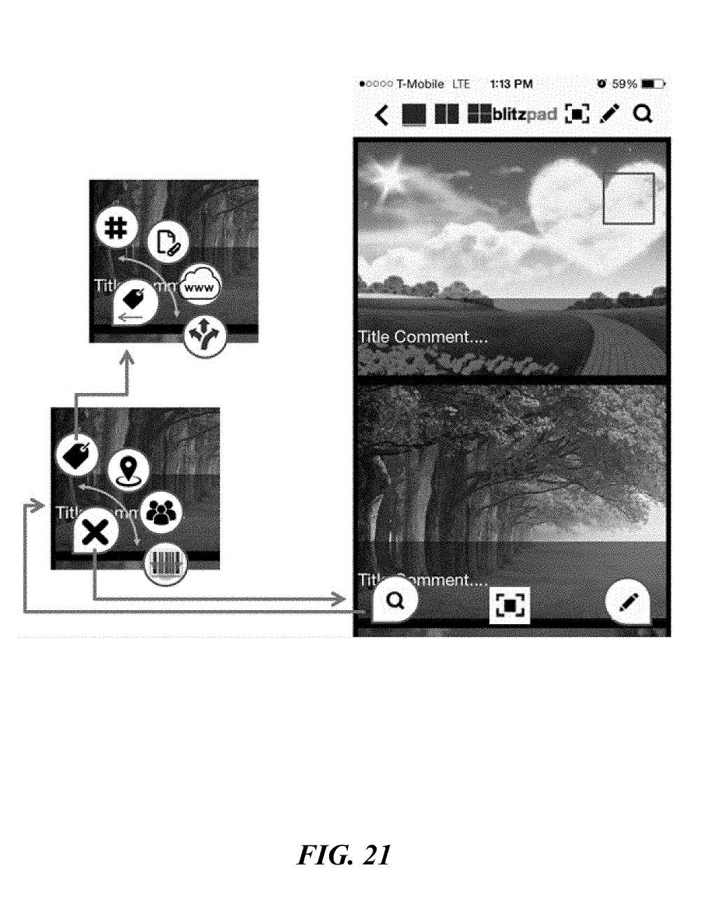

FIG. 21 illustrates a new interface to augment menu systems, in one embodiment. Traditional menus that pop up from the bottom or top of the screen offer only a single list of choices. There is no way to pair up two choices, for example. The system provides an interface through which a user can select multiple choices. In one embodiment, when a user pushes a button in the lower left corner, a set of choices (each an icon) fans out around the original button. If the user clicks people, for example, the user can search based on people. The main button then becomes people, and the user can click that to have a set of choices fan out again and make a second choice. For example, the user might select files to find files associated with that user. The combination of people and files narrows down the content that the system will search for the user.

In some embodiments, this type of choice is available on the left for searching, and on the right for creating. By selecting things in both, and then dragging from search to create, the user can inform the system that the user wants to create a new content item based on the search criteria selected in the search menu. This allows the user to create a workflow that augments the newly created content item in accordance with the chosen method from the left menu. Having two dials open with unique selections and dragging from one to the other provides a new method of user interface. From the foregoing, it will be appreciated that specific embodiments of the system have been described herein for purposes of illustration, but that various modifications may be made without deviating from the spirit and scope of the invention.

The system provides a hierarchy where each node is a leaf or “super-leaf.” In a typical menu, you navigate through a hierarchical system to get to a single leaf. Here, each node is a hierarchical node in itself, which can lead the user to a new set of types of choices. In some embodiments, if a user long presses on a node, there are more nodes within that node that the user can choose from. Eventually the user will arrive at a leaf, like a typical menu system, but the system is richer and provides the user more choices to get there.

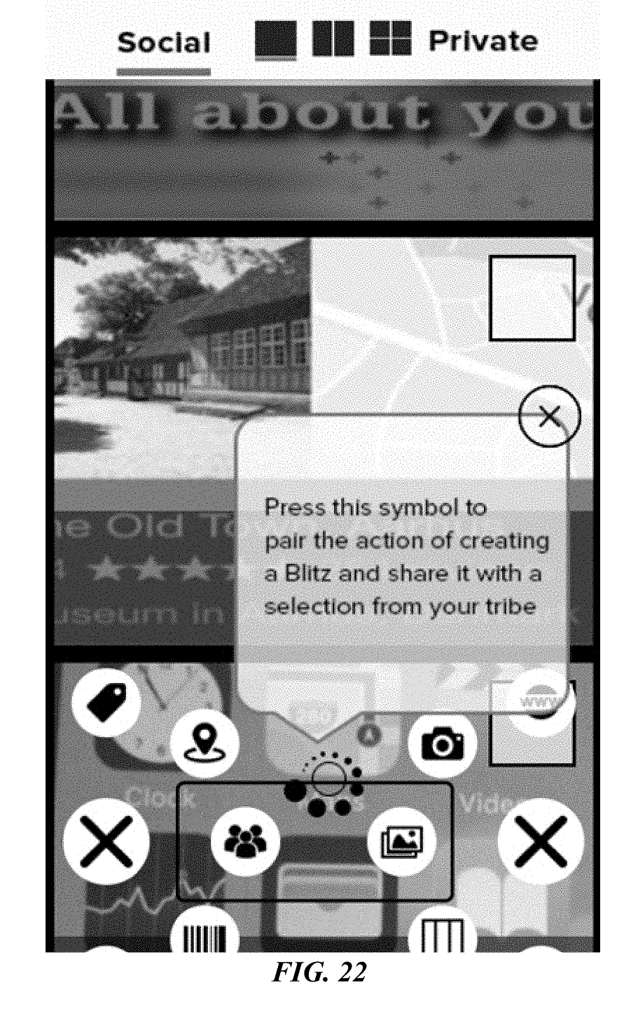

FIG. 22 illustrates a user interface control that appears when there are two options facing each other, in one embodiment. The user interface control appears in the middle that can be pressed by the user to select a combined action.

From the foregoing, it will be appreciated that specific embodiments of the system have been described herein for purposes of illustration, but that various modifications may be made without deviating from the spirit and scope of the invention.

I/We claim:

1. A system as substantially shown and described herein, and equivalents thereof.

2. A method as substantially shown and described herein, and equivalents thereof.
